(19) United States
(12) Patent Application Publication
(10) Pub. No.: US 2021/0001324 A1
(43) Pub. Date: Jan. 7, 2021

(54) Safety Cabinet

(71) Applicant: Hitachi Industrial Equipment Systems Co., Ltd., Chiyoda-ku, Tokyo (JP)

(72) Inventors: Takeshi KANEKO, Tainai-shi (JP); Takahiro KASHIMA, Tokyo (JP)

(21) Appl. No.: 16/976,807

(22) PCT Filed: Jan. 29, 2019
(86) PCT No.: PCT/JP2019/002988

§ 371 Date: Aug. 31, 2020

(30) Foreign Application Priority Data
Apr. 24, 2018 (JP) 2018-083428

(51) Int. Cl. B01L 1/00; F24F 7/007; F24F 11/72

(52) U.S. Cl. CPC B01L 1/00; F24F 11/72; F24F 7/007

(57) ABSTRACT

A safety cabinet includes an operation stage on which an operation is performed; an operation space in which an operator performs the operation; a front panel disposed in a front surface of the operation space; an operation opening connected to the operation space; exhausting means that suctions air from the operation opening and exhausts air in the operation space outside the safety cabinet through air purifying means; and height adjusting means that adjusts a height to allow the operator to perform the operation.

### TECHNICAL FIELD

The present invention relates to a safety cabinet which is equipment that realizes a safe operating environment when handling microorganisms, pathogens, or the like.

### BACKGROUND ART

In the related art, when microorganisms, pathogens, or the like are handled, a safety cabinet is used to maintain an internal purity and physically isolate the microorganisms and the pathogens to be handled from the human and the environment to thereby safely perform an operation.

As the safety cabinet, there are known techniques disclosed in Patent Documents 1 and 2.

Patent Document 1 discloses a safety cabinet that exhausts the air outdoors through an open duct connection and issues an alarm when there is a possibility that a defect occurs in an outdoor exhaust duct system to cause the exhaust air of the safety cabinet, the exhaust air containing a small amount of volatile noxious substances, to leak from an opening portion of an open duct to a laboratory.

Patent Document 2 discloses a technique of disposing a display device such as a monitor screen provided in a safety cabinet in a position where the display device is not affected by the diffused reflection of light from a fluorescent lamp or a deterioration by irradiation from a sterilization lamp and does not become resistance to an airflow path, protecting the display device also from a decontamination operation, and preventing contamination from adhering to a portion related to display, when an operator performs an operation using the safety cabinet while confirming a standard operation procedure document or specimen data.

### CITATION LIST

### Patent Document

Patent Document 1: JP 2017-78527 A
Patent Document 2: JP 2016-165249 A

### SUMMARY OF THE INVENTION

### Problems to be Solved by the Invention

In order to maintain an air barrier, the opening portion of the safety cabinet is limited in size to the extent that the operator can put the hands thereinto. However, depending on the device to be installed in the safety cabinet, there are various devices such as a device for which an operation is performed from front and a device for which an operation is performed from above, and operability may be impaired at the fixed opening position.

Patent Document 1 and Patent Document 2 do not disclose any technique where the operator adjusts the height of the opening portion to a height to easily perform an operation.

An object of the invention is to provide a safety cabinet that can be adjusted to a height to allow an operator to easily perform an operation.

### Solutions to Problems

According to one preferable example of the invention, there is provided a safety cabinet including: an operation stage on which an operation is performed; an operation space in which an operator performs the operation; a front panel disposed in a front surface of the operation space; an operation opening connected to the operation space; exhausting means that suctions air from the operation opening and exhausts air in the operation space outside the safety cabinet through air purifying means; and height adjusting means that adjusts a height to allow the operator to perform the operation.

### Effects of the Invention

According to the invention, it is possible to obtain the safety cabinet that can be adjusted to a height to allow the operator to easily perform an operation.

### BRIEF DESCRIPTION OF THE DRAWINGS

FIG. 1 is a schematic front view of a safety cabinet in a first embodiment.

FIG. 2 is a schematic side view of the safety cabinet when a cross section A-A′ in FIG. 1 is viewed from right.

FIG. 3 is a schematic side view of the safety cabinet in which an air flow is indicated by arrows.

FIG. 4 is a schematic side view of the safety cabinet for describing the first embodiment.

FIG. 5 is a schematic side view of the safety cabinet in a case where a storage region for when an upper part of a front panel is moved is provided on an upper side of a housing.

FIG. 6 is a schematic side view of the safety cabinet in a case where the front panel is divided into three parts.

FIG. 7 is a view describing a movement mechanism of the front panel in a case where the front panel is divided into the three parts.

FIG. 8 is a schematic side view of the safety cabinet illustrating an example of the movement mechanism of the front panel.

FIG. 9 is a schematic side view of a safety cabinet for describing a second embodiment.

FIG. 10 is a schematic side view of a safety cabinet for describing a modification example of the second embodiment.

FIG. 11 is a schematic side view of a safety cabinet for describing a third embodiment.

FIG. 12 is a schematic side view of a safety cabinet for describing a fourth embodiment.

### MODE FOR CARRYING OUT THE INVENTION

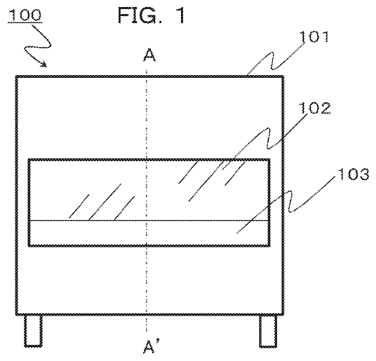

Hereinafter, embodiments will be described with reference to FIGS. 1 to 12.

### First Embodiment

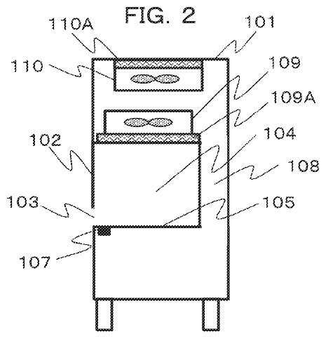

FIG. 1 illustrates a schematic front view of a safety cabinet. In addition, FIG. 2 illustrates a schematic side view of the safety cabinet when a cross section A-A′ in FIG. 1 is viewed from right.

An opening is provided in a central region of a housing 101 of a safety cabinet 100 and an operation space 104 is provided therebehind. A front panel 102 is provided on a front surface side of the operation space 104 to block an upper portion of the opening, an operation opening 103 is provided below the front panel 102, and an operator inserts the hands into the operation space 104 from the operation opening 103 to perform an operation. The front panel 102 is made of a transparent material such as a glass, and the operator can see an operation through the front panel.

An operation stage 105 which is substantially flat is provided in a bottom surface of the operation space 104, and the operator performs an operation on the operation stage. A suction port 107 leading downward is provided near the operation opening 103 on a front side of the operation stage 105. The suction port 107 is formed as, for example, a slit extending along the operation opening 103 in a rightward and leftward direction of the housing 101. A back flow path 108 leading from the suction port 107 to an upper portion of the housing 101 is provided on a back surface side of the operation space 104.

A blowout side fan filter unit (FFU) 109 is provided on an upper side of the operation space 104. The blowout side FFU 109 includes a fan that is air blowing means driven to rotate by a motor, and a filter that removes microparticles, for example, a HEPA filter 109A that is air purifying means. Purified air from which microparticles are removed is blown out into the operation space 104 by the blowout side FFU 109. An exhaust side fan filter unit (FFU) 110 is provided in the upper portion of the housing 101 to remove microparticles from a part of air through a filter, for example, a HEPA filter 110A and to exhaust the part of air outside the device.

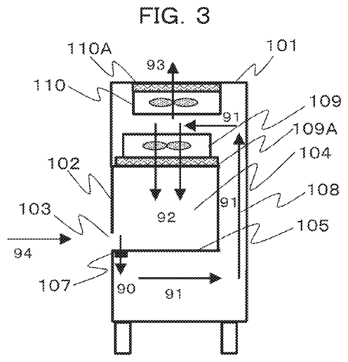

In FIG. 3, an air flow during operation of the safety cabinet is indicated by arrows. Air 90 which is suctioned from the suction port 107 on a front surface side of the operation stage 105 is blown, as denoted by reference sign 91, into the operation space 104 from the blowout side FFU 109 through a lower portion of the housing 101, the back flow path 108, and the upper portion of the housing 101. Since purified air from which microparticles are removed by the HEPA filter 109A of the blowout side FFU 109 is blown into the operation space 104, the operation space 104 is maintained in a purified state.

In this case, when only an air flow denoted by reference sign 92 flows into the operation space 104, air in the operation space may leak outside, which is a concern. For this reason, the exhaust side FFU 110 is provided and a portion of air is discharged outside through the HEPA filter 110A. Accordingly, the pressure in the operation space 104 decreases, and an air flow 94 which is to be introduced from outside to inside through the operation opening 103 below the front panel 102 is generated. When the air flow 94 flows into the operation space 104 as it is, the purity of the operation space deteriorates.

However, the air amount of the air flow 92 that is blown out from the blowout side FFU 109 into the operation space 104 and the air amount of an air flow 93 that is exhausted outside from the exhaust side FFU 110 are properly controlled to cause all of the air 94 flowing in from the operation opening 103 and the majority of the air 92 blown into the operation space 104 to be suctioned from the suction port 107, and thus an atmospheric barrier (air barrier) that prevents the air 94 from flowing into the operation space 104 from the operation opening 103 is formed by the air flow 92 that is blown out into the operation space 104.

Accordingly, it is possible to realize an equilibrium state where the air from outside does not contaminate the operation space 104 and non-purified inside air does not leak outside. In addition, accordingly, even when the operator inserts the hands into the operation space 104 through the operation opening 103 to perform an operation, it is possible to realize the maintenance of purity and the prevention of contamination.

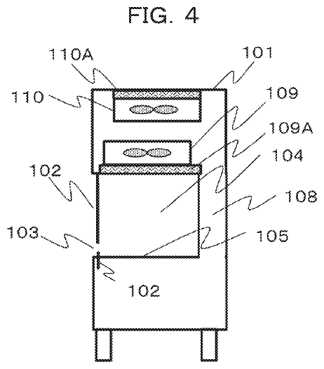

FIG. 4 is a schematic side view of the safety cabinet 100 for describing a first embodiment. In the first embodiment, the front panel 102 is configured to be divided into upper and lower parts. A movement mechanism capable of moving the front panel 102 upward and downward is provided as height adjusting means that adjusts the height to allow the operator to perform an operation. The front panel 102 may be completely separated, or one front panel may be provided with an opening portion having a rectangular shape to include a movement mechanism that opens and closes the opening portion. A storage region for when the front panel is moved is provided on a housing 101 side in advance. In FIG. 4, a storage region storing the lower part of the front panel 102 is provided on a lower side of the housing 101.

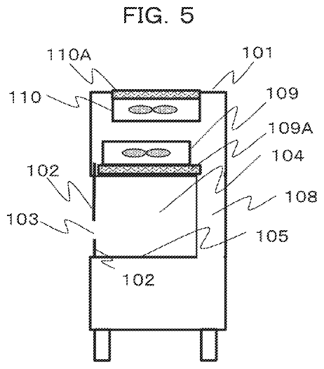

FIG. 5 is a schematic side view of the safety cabinet 100 in a case where a storage region for when the upper part of the front panel 102 is moved is provided on an upper side of the housing. The front panel 102 may be divided into a plurality of parts, particularly, into three or more parts.

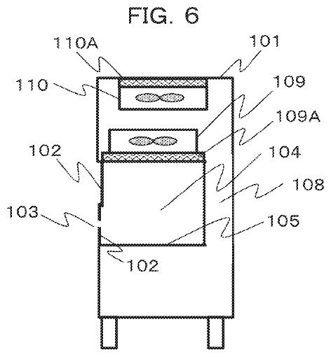

FIG. 6 illustrates a schematic side view of the safety cabinet 100 in a case where the front panel 102 is divided into three parts.

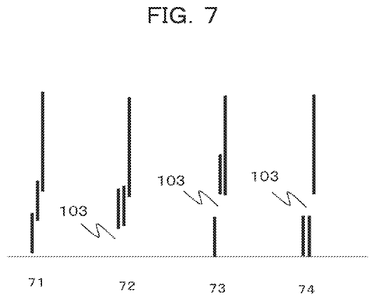

FIG. 7 is a view describing an example of a movement mechanism of the front panel 102 in a case where the front panel 102 is divided into the three parts. A view denoted by reference sign 71 illustrates a state where the front panel 102 is closed. A view denoted by reference sign 72 illustrates a state where the operation opening 103 is set downward. A view denoted by reference sign 73 illustrates a first example where the operation opening 103 is set upward. A view denoted by reference sign 74 illustrates a second example where the operation opening 103 is set upward.

In order to maintain the air barrier, the height of the operation opening 103 is limited to approximately 200 mm. According to the first embodiment, in order to improve the operability, while the height of the operation opening 103 is maintained, the position of the operation opening 103 in the front panel 102 is raised; and thereby, an operation in the operation space can be easily carried out.

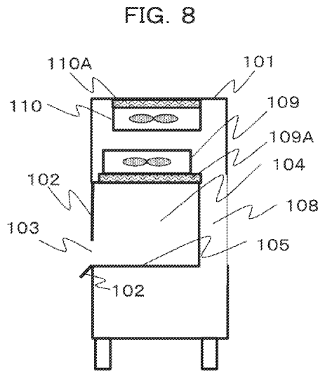

FIG. 8 is a schematic side view of the safety cabinet 100 illustrating another example of the movement mechanism of the front panel. The upper part of the front panel 102 is moved upward to be stored in the storage region of the housing 101, and thus the operation opening 103 is formed. The lower part of the front panel 102 is rotatable around a portion of the lower part, which is connected to the housing 101, and the lower part of the front panel 102 is rotated to adjust the position of the lower part to an upper side or a lower side, so that the operation opening 103 is formed. The upper part of the front panel 102 may be rotated and the lower part of the front panel 102 may be stored in the housing 101. In addition, both of the upper and lower parts of the front panel 102 may be rotated to form the operation opening 103.

Since the front panel 102 is rotated, the storage region is not required to be provided in the housing 101, and thus the degree of freedom in configuring the safety cabinet 100 is improved.

### Second Embodiment

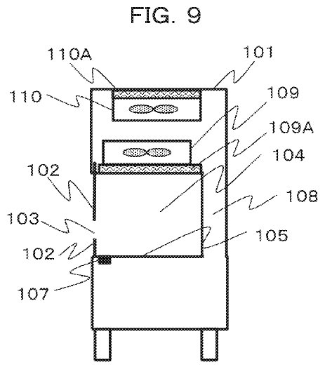

FIG. 9 is a schematic side view of a safety cabinet for describing a second embodiment.

The second embodiment is an embodiment where the operation of the exhaust side FFU 110 is changed according to the position of the operation opening 103. The second embodiment is an embodiment where when a lower portion of the operation opening 103 is located above the operation stage 105, the operation of the exhaust side FFU 110 is enhanced. For example, a door position sensor (unillustrated) is provided in the storage region for when the upper part of the front panel 102 is moved. Since the operation opening 103 is provided on the upper side, the door position sensor detects that the front panel 102 is stored on the upper side of the housing 101.

As illustrated in FIG. 9, when the position of the operation opening 103 is set on the upper side, the distance between the suction port 107 and the operation opening 103 is longer than when the operation opening 103 is set on the lower side, and thus the outside air flows easily into the operation space 104.

Therefore, when the door position sensor detects that the operation opening 103 is provided on the upper side, a control unit (unillustrated) of the exhaust side FFU 110 controls the exhaust side FFU 110 so as to enhance an operation such as accelerating the rotation of the exhaust side FFU 110, to thereby increase the amount of exhaust air to the outside and enhance the negative pressure so as for a return side air flow (equivalent to the air flows 90, 91, and 92 in FIG. 3) to occur. In such a case, since the amount of atmosphere to be introduced from the suction port 107 is increased and a front panel 102 side of a downflow (air flow 92 in FIG. 3) from the blowout side FFU 109 is enhanced, the function of the air barrier is enhanced, and thus the outside air can be prevented from infiltrating into the operation space 104.

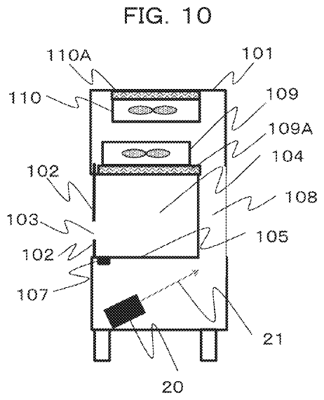

In order to enhance the downflow, besides enhancing the operation of the exhaust side FFU 110, as illustrated in FIG. 10, an air blowing unit 20 may be provided along the return side air flow to blow high-pressure air 21 when the door position sensor detects that the operation opening 103 is provided on the upper side.

Accordingly, the speed of the return side air flow is increased. As a result, the negative pressure immediately below the suction port 107 is increased and the suction amount is increased. In addition, the above operation may be combined with an operation such as increasing the rotational speed of the fan of the exhaust side FFU 110 to enhance the return side air flow. A large amount of the high-pressure air 21 may be stored in a high-pressure tank or the like in advance.

### Third Embodiment

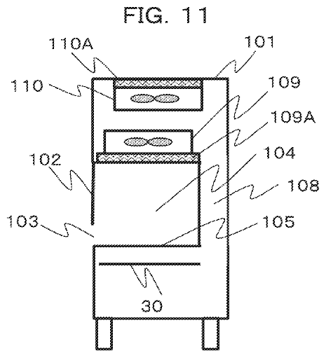

FIG. 11 is a schematic side view of the safety cabinet 100 for describing a third embodiment. In the third embodiment, a stage height adjusting mechanism (unillustrated) that lowers or raises the entirety or a part of an operation stage 30 in the housing 101 is provided as height adjusting means that adjusts the height to allow the operator to perform an operation.

For example, a button or a touch panel is operated to enable the stage height adjusting mechanism to adjust the height of the stage 30. The height adjustment may be mechanically done, for example, can be realized by power such as hydraulic pressure. According to the present embodiment, the relative position of the operation stage 30 with respect to the operation opening 103 formed by moving the front panel 102 can be adjusted in a vertical direction.

### Fourth Embodiment

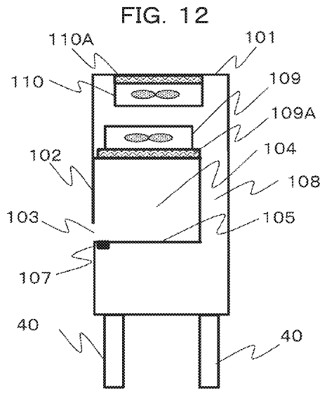

FIG. 12 is a schematic side view of the safety cabinet 100 for describing a fourth embodiment. In the fourth embodiment, a support portion length extending and contracting mechanism that extends and contracts the length of a leg 40 which is a support portion supporting the safety cabinet is provided as height adjusting means that adjusts the height to allow the operator to perform an operation. A button or a touch panel is operated to enable the support portion length extending and contracting mechanism to extend and contract the length of the leg 40 to thereby change the overall height of the safety cabinet 100. The extension and contraction may be mechanically done, for example, can be easily realized by hydraulic pressure or the like.

As a result, the position of the operation opening 103 relative to the operator can be adjusted upward and downward. According to the present embodiment, it is possible to improve the operability without changing the front panel or the stage. Furthermore, when the above configuration is combined with adjusting the height of the operation stage 30 illustrated in the third embodiment, the operability is further improved. In addition, the above configuration may be combined with the configuration where the front panel 102 is moved to move the position of the opening portion.

### REFERENCE SIGNS LIST

20 Air blowing unit
30 Operation stage
40 Leg
100 Safety cabinet
101 Housing
102 Front panel
103 Operation opening
104 Operation space
105 Operation stage
107 Suction port
108 Back flow path
109 Blowout side FFU
109A Blowout side HEPA filter
110 Exhaust side FFU
110A Exhaust side HEPA filter

1. A safety cabinet comprising:
an operation stage on which an operation is performed;
an operation space in which an operator performs the operation;
a front panel disposed in a front surface of the operation space;
an operation opening connected to the operation space;
exhausting means that suctions air from the operation opening and exhausts air in the operation space outside the safety cabinet through air purifying means; and
height adjusting means that adjusts a height to allow the operator to perform the operation.

2. The safety cabinet according to claim 1,
wherein the height adjusting means is a front panel movement mechanism by which the front panel is movable.

3. The safety cabinet according to claim 2,
wherein the front panel is divided into a plurality of parts.

4. The safety cabinet according to claim 2, further comprising:
a storage region storing the front panel.

5. The safety cabinet according to claim 2,
wherein the front panel movement mechanism is a mechanism by which the front panel is rotatable.

6. The safety cabinet according to claim 1,
wherein a control unit of the exhausting means is provided and the control unit changes an operation of the exhausting means according to a position of the operation opening.

7. The safety cabinet according to claim 1, further comprising:
an air blowing unit,
wherein the air blowing unit blows air according to a position of the operation opening.

8. The safety cabinet according to claim 1,
wherein the height adjusting means is an operation stage height adjusting mechanism that adjusts a height of the operation stage.

9. The safety cabinet according to claim 1,
wherein the height adjusting means is a support portion length extending and contracting mechanism that extends and contracts a length of a support portion.

10. The safety cabinet according to claim 1,
wherein the height adjusting means is configured by combining a plurality of mechanisms among a front panel movement mechanism by which the front panel is movable, an operation stage height adjusting mechanism that adjusts a height of the operation stage, and a support portion length extending and contracting mechanism that extends and contracts a length of a leg.

11. The safety cabinet according to claim 6,
wherein when the position of the operation opening is high, the control unit enhances the operation of the exhausting means.
